(19) United States
(12) Patent Application Publication
(10) Pub. No.: US 2023/0090694 A1
(43) Pub. Date: Mar. 23, 2023

(54) IDENTIFICATION MARK-BEARING GLASS PLATE AND METHOD OF MANUFACTURING IDENTIFICATION MARK-BEARING GLASS PLATE

(71) Applicant: AGC Inc., Tokyo (JP)

(72) Inventors: Kei NISHIMOTO, Tokyo (JP); Toru IMAI, Tokyo (JP)

(73) Assignee: AGC Inc., Tokyo (JP)

(21) Appl. No.: 18/071,280

(22) Filed: Nov. 29, 2022

Related U.S. Application Data
(63) Continuation of application No. PCT/JP2021/018594, filed on May 17, 2021.

(30) Foreign Application Priority Data
Jun. 1, 2020 (JP) 2020-095748

(51) Int. Cl. B23K 26/364; B23K 26/40

(52) U.S. Cl. CPC B23K 26/364; B23K 26/40; B23K 2103/54

(57) ABSTRACT

A method of manufacturing an identification mark-bearing glass plate includes forming an identification mark on a main surface of a glass plate by emitting a UV laser beam.

### CROSS-REFERENCE TO RELATED APPLICATIONS

The present application is a continuation application filed under 35 U.S.C. 111 (a) claiming benefit under 35 U.S.C. 120 and 365 (c) of PCT International Application No. PCT/JP2021/018594 filed on May 17, 2021 and designating the U.S., which claims priority to Japanese Patent Application No. 2020-095748 filed on Jun. 1, 2020, the entire contents of which are incorporated herein by reference.

### BACKGROUND OF THE INVENTION

### 1. Field of the Invention

The present disclosure relates to an identification mark-bearing glass plate and a method of manufacturing the identification mark-bearing glass plate.

### 2. Description of the Related Art

It is known that a surface of a glass plate is partially roughened as a method by which an identification mark representing a standard, a product name, a manufacturer, or the like is provided on the glass plate. For example, Patent Document 1 describes the forming of a rough surface on one main surface of a glass plate by shot-blasting (sandblasting) the one main surface with abrasive sand. Thus, a predetermined design can be produced by the contrast between the rough surface and the parts other than the rough surface, thereby forming an identification mark.

### CITATION LIST

### Patent Literature

Patent Document 1: Japanese Unexamined Patent Application Publication No. 2017-48110

### SUMMARY OF THE INVENTION

In the sandblasting method as described in Patent Document 1, a stencil plate (mask) with a portion corresponding to the roughened surface removed is placed on the main surface of the glass, and then abrasive sand is blasted to roughen the area within the removed region that is not covered by the stencil plate. Here, in a case where the design of the identification mark includes a continuous ring, it is imperative to use multiple separate stencil plates in order to form a single design. However, it is difficult to accurately position such separate stencil plates with respect to each other to finish the desired mark.

Moreover, nowadays, the design of identification marks is becoming more complicated, and there is a growing demand for marks to be formed in a design that includes a rough surface that is miniscule or thin in shape. However, with the conventional method of sandblasting, there are limits to the extent to which the diameter of the abrasive sand can be made smaller, and consequently the mark may become blurred without roughening the miniscule area.

Therefore, one aspect of the present disclosure is to provide a method of manufacturing an identification mark-bearing glass plate by which a more accurate and clearer identification mark can be formed on the glass plate.

One aspect of the present disclosure is a method of manufacturing an identification mark-bearing glass plate, the method including forming an identification mark on a main surface of a glass plate by emitting a UV laser beam.

According to one aspect of the present disclosure, a method of manufacturing an identification mark-bearing glass plate can be provided in which a more accurate and clearer identification mark can be formed on the glass plate.

### BRIEF DESCRIPTION OF THE DRAWINGS

FIG. 1A is a schematic diagram of a device used for manufacturing identification mark-bearing glass plates according to one embodiment of the present disclosure and FIG. 1B is an enlarged view of the identification mark 20 illustrated in FIG. 1A;

FIG. 2A is a diagram illustrating an example of an identification mark and FIG. 2B is a diagram of a partial enlargement of the identification mark; and

FIGS. 3A to 3C are electron micrographs of portions of the identification marks formed by Examples 1 to 3.

### DETAILED DESCRIPTION OF THE PREFERRED EMBODIMENTS

Hereinafter, embodiments of the present disclosure are described in detail below with reference to the drawings. In each drawing, unless otherwise noted, the same or corresponding configurations are denoted by the same numerals, and accordingly, duplicate description thereof may be omitted. In addition, the drawings are schematic to aid understanding of the invention, and the scale in the drawings may be different from the actual scale.

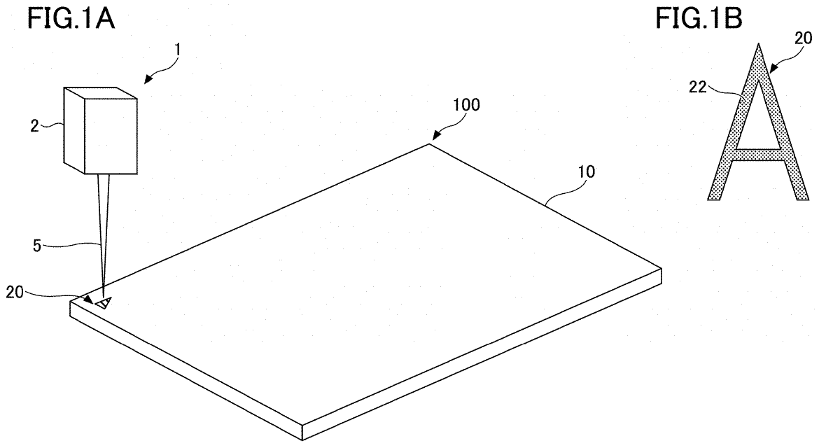

FIG. 1A is a schematic diagram of a device used in the method of manufacturing the identification mark-bearing glass plate 100 according to the present embodiment. As illustrated in FIG. 1A, in this configuration, the identification mark 20 is formed by irradiating the main surface of a glass plate 10 with the UV laser beam 5 emitted from a laser beam generation unit 2 in the UV laser beam generation device 1.

The identification mark 20 is a mark for displaying, on the glass plate, information regarding the production of the glass plate, the quality of the glass plate, or both the production and the quality of the glass plate, and more specifically, it is a mark indicating one or more of the following: manufacturer, product name, part number, model number, date of manufacture, processing conditions or inspection conditions, and certification of a standard such as JIS, ISO, and the like. The identification mark 20 may be a letter, number, figure, logo, or the like, or may be a combination of two or more of these. Moreover, the identification mark may include a mark intended primarily for decorative purposes, and not intended for displaying specific information. In the schematic diagram in FIG. 1A, an example in which the letter ‘A’ of the alphabet is formed as the identification mark 20 is illustrated, and in FIG. 1B, an enlarged view of the identification mark 20 is illustrated.

The position where the identification mark 20 is formed on the main surface of the glass plate 10 is not particularly limited, but when the identification mark-bearing glass plate 100 is used as a window, it is preferable that the identification mark 20 is provided in a position that does not obstruct the view of a user or an occupant. More specifically, the identification mark 20 is preferably provided in a predetermined position in vicinity of the peripheral edge of the glass plate, and more preferably in vicinity of a horizontal end of the glass plate, a vertical end of the glass plate, or a combination thereof, in a state where the glass plate is attached to a vehicle, an architectural structure, or the like. For example, in the case where the glass plate is substantially rectangular, it is preferable that the identification mark 20 be formed at or in vicinity of one of the corners of the glass plate 10 as illustrated in FIG. 1A.

The glass plate 10 bearing the identification mark 20 may be inorganic glass, more specifically soda-lime silicate glass, aluminosilicate glass, borate glass, lithium aluminosilicate glass, borosilicate glass, or the like. The glass plate 10 may be non-tempered glass or tempered glass subjected to thermal tempering treatment or chemical tempering treatment. The non-tempered glass is made by forming molten glass into a plate shape and annealing this. The tempered glass has a compressive stress layer formed on the surface of non-tempered glass and may be either physically tempered glass (e.g., thermally tempered) or chemically tempered glass. In a case where the tempered glass is thermally tempered glass, the surface of the glass may be strengthened by quenching the uniformly heated glass plate from a temperature near the softening point, and by inducing a compressive stress on the glass surface from the temperature difference between the glass surface and the inside of the glass. In a case where the tempered glass is chemically tempered glass, the surface of the glass may be strengthened by inducing a compressive stress on the glass surface using an ion exchange method or the like.

The glass plate 10 is transparent and the visible light transmittance of the glass plate 10 measured using a measurement method in compliance with Japanese Industrial Standard JIS R 3106:1998 is preferably 70% or less and more preferably 60% or less. In addition, the glass plate 10 may be colored to the extent that the transparency of the glass plate 10 is not impaired. In the case where the glass plate 10 is colored, the color and shade are not particularly limited as long as the glass plate 10 can absorb ultraviolet rays at least in the area where the identification mark 20 is formed.

The thickness of the glass plate 10 may be 0.2 mm to 5 mm, preferably from 0.3 mm to 2.4 mm. When a glass plate 10 is laminated together with another glass plate to be used as laminated glass and the glass plate 10 is situated on the vehicle-exterior side, the thickness of the glass plate 10 is preferably 1.1 mm to 3 mm in the thinnest part. When the plate thickness of the glass plate situated on the vehicle-exterior side is 1.1 mm or more, the strength such as stone chip resistance is sufficient, and when the plate thickness of the glass plate is 3 mm or less, the weight of the laminated glass is not excessive, which is preferable in terms of the fuel efficiency of the vehicle. The plate thickness of the glass plate situated on the vehicle-exterior side is, in the thinnest part, more preferably 1.8 mm to 2.8 mm, even more preferably 1.8 mm to 2.6 mm, even more preferably 1.8 mm to 2.2 mm, and even more preferably 1.8 mm to 2.0 mm. When the glass plate 10 is laminated together with another glass plate to be used as laminated glass and the glass plate 10 is situated on the vehicle-interior side, the thickness of the glass plate 10 is preferably 0.3 mm to 2.3 mm. The plate thickness of the glass plate situated on the vehicle-interior side is 0.3 mm or more for better handleability, and 2.3 mm or less so the weight does not become excessive.

It is to be noted that the identification mark-bearing glass plate 100 manufactured by the method according to the present embodiment may have a singularly-bent shape in which the identification mark-bearing glass plate 100 is formed by being bent in only one direction, for example, in a lateral direction or in a vertical direction of the automobile while attached to the opening of the automobile. Alternatively, the identification mark-bearing glass plate may have a complex bent shape in which the identification mark-bearing glass plate is formed by being bent in both a lateral direction and in a vertical direction. The bend forming may be gravity forming, press forming, or the like. Such bend forming may be performed after the identification mark is formed on the glass plate, or may be performed after the glass plate is manufactured, and the identification mark may be formed on a main surface using a UV laser. In a case where the identification mark-bearing glass plate is curved by being bend formed at a predetermined curvature, the radius of curvature of the glass plate may be 1,000 mm to 100,000 mm.

The identification mark-bearing glass plate 100 manufactured in the present embodiment may be suitably used as window glass for vehicle glass such as a windshield, rear glass, side glass, roof glass, or the like. The identification mark-bearing glass plate 100 may be used as glass for building materials. The identification mark-bearing glass plate may be laminated together with another glass plate via an interlayer such as a thermoplastic resin to form laminated glass. In such a case, the laminated glass may be constructed after the identification mark is formed on the glass plate, or the identification mark may be formed after the laminated glass is constructed.

In the case where the identification mark-bearing glass plate 100 manufactured in the present embodiment is used as a vehicle window, a shielding layer (also called black ceramic) may be provided along the periphery of the identification mark-bearing glass plate 100. The shielding layer is a layer that protects sealants or the like for adhering and holding a glass plate for a vehicle to the car body, and can be formed by applying and baking a paste containing dark pigments and glass powder. The identification mark is preferably formed at a position not overlapping the shielding layer. The shielding layer can be provided after the identification mark 20 is formed on the glass plate.

It is to be noted that the glass plate 10 may be coated with a coating layer for imparting ultraviolet ray shielding, infrared ray shielding, anti-fogging, or other effects to the entirety of one or both main surfaces. The identification mark 20 may be formed by irradiating the surface of the glass plate 10, coated with the coating layer, with a UV laser beam. However, it is preferable that the glass plate 10 has no coating layer on the main surface at least where the identification mark 20 is formed or at least on the side where the identification mark 20 is formed. Moreover, it is preferable that the glass surface is exposed, and that the identification mark 20 is formed on the uncoated main surface.

In the method according to the present embodiment, the surface layer of the main surface of the glass plate 10 is shaved or engraved by irradiating the main surface with the UV laser beam 5, thereby forming an area containing fine unevenness (the roughened area) and forming the identification mark 20. For this reason, once the identification mark is formed, the visibility of the identification mark is unlikely to be lost compared with a method in which a colorant layer or the like is added by printing or the like. That is, the shape of the identification mark can be maintained without any added layer peeling off in the subsequent processing step or when the glass plate is used.

A UV laser beam generation device (or UV laser marker) 1 used may be a scanning type. More specifically, it is preferable that the UV laser beam 5 can be scanned at least along the main surface of the glass plate 10 in plane directions (that is, along two axes) of the main surface of the glass plate 10. In such a case, the position of the glass plate 10 may be fixed and the laser beam generation device 1 may be configured to move freely along the main surface of the glass plate 10 in a direction, or, the position of the laser beam generation device 1 may be fixed and the glass plate 10 may be configured to move freely along the main surface in a direction. Although the irradiation direction of the UV laser beam 5 to the glass plate 10 is not particularly limited, it is preferable that the UV laser beam 5 is emitted perpendicular to the glass plate 10.

Thus, in the present embodiment, since the roughened area constituting the design of the identification mark 20 can be formed by scanning the surface of the glass plate 10 with the UV laser beam, a continuous annular or closed linear design can also be easily depicted. For example, if the letter ‘A’ of the alphabet, as illustrated in FIG. 1B, is to be depicted by a roughened area 22, the upper portion of the letter ‘A’ has a continuous triangular annular portion, but a design containing such a portion can also be formed by scanning the laser beam. Therefore, by the method using the UV laser according to this configuration, the identification mark of the design which is difficult to form by the sandblasting method, which requires a stencil plate or the like, can be formed more accurately. In addition, identification marks of complex designs, which are represented by roughening miniscule or thin linear areas, can be formed more clearly.

The wavelength of the laser beam used in the present embodiment may be in the ultraviolet range, that is, 400 nm or less, preferably 380 nm or less, and more preferably 360 nm or less. The lower limit of the wavelength is not particularly limited but may be 10 nm or more, and preferably 100 nm or more. With a wavelength in the ultraviolet range, the absorption rate of the laser beam is high with respect to the glass, and thus the glass plate can be processed well. Especially at wavelengths equal to or less than 360 nm, absorption is observed in many colored glass plates, and thus such wavelengths can accommodate various forms of glass.

In addition, since the laser beam has a wavelength in the ultraviolet range, the spot diameter of the laser beam (the diameter of the laser beam upon the surface of the glass plate being directly irradiated with the laser beam; also referred to as, for example, an illuminated spot diameter) can be reduced, and thus a narrow width groove can be formed by the laser beam scanning. By forming a plurality of narrow width grooves formed to be spaced apart from each other by laser beam scanning, a fine unevenness can be formed within the roughened area, and the fine parts that diffuse-reflect can be dispersed throughout the roughened area, thereby imparting a visual effect where the entire roughened area appears to be homogeneously colored in (also referred to as a sense of homogeneity). This enhances the aesthetic of the roughened area. Further, the visual contrast between the roughened area and the non-processed area that is not roughened can be increased, and thus the identification mark 20 can be easily recognized.

Furthermore, at wavelengths in the ultraviolet range, less heat is generated during processing because the energy of the photons in the laser beam is large. Therefore, even when the glass is irradiated with a laser beam at a wavelength in the ultraviolet range, cracks or the like are unlikely to form in the glass. Since cracks form irregularly, depending on the size and depth of the cracks, the cracks may be visible as an uneven scaly pattern, and this may reduce the sense of homogeneity within the roughened area. Also, the outline of the roughened area may become unclear. To address this, the present embodiment reduces or prevents an occurrence of cracks or the like in the glass, thereby enhancing the sense of homogeneity, and thus, an identification mark with higher visibility and an enhanced aesthetic can be obtained. In addition, a decrease in the strength of the glass plate 10 due to an occurrence of cracks or the like can be prevented.

The technique of generating laser beam is not particularly limited as long as the wavelength of the light ultimately emitted on the glass plate 10 is within the ultraviolet range, and, as such, a solid-state laser, a gas laser, or a liquid laser may be used. For example, the UV laser beam may be higher harmonics obtained by wavelength conversion of the light of the fundamental frequency, and as a specific example, the third and fourth harmonics of a solid-state laser such as a Nd:YVO₄ laser or a Nd:YAG laser can be used. The UV laser beam may be continuous wave (CW) or pulsed. In the case where the laser beam is a pulsed wave, the effect of heat can be further reduced and an occurrence of cracks or the like in the glass plate 10 can be further prevented.

The identification mark 20 can be represented by the roughened area 22 as described above (FIG. 1B), and by the visual contrast between the roughened area 22 and the non-processed area that is an area other than the roughened area 22, that is, by the contrast of transparency or reflectivity. In other words, at least part of the identification mark 20 has a roughened area 22 in which at least part of the surface of the glass plate 10 is roughened. Since the roughened area 22 has multiple grooves spaced apart from each other throughout the entire area, the transparency of the roughened area 22 is lower than the transparency of the non-processed area that is an area other than the roughened area 22.

In the manufacturing method according to the present embodiment, in the step of forming the identification mark 20, it is preferable to emit the UV laser beam such that a plurality of grooves (elongated recesses in a plan view) spaced apart in a predetermined direction are formed. In other words, it is preferable that the roughened area 22 is formed by an aggregate of multiple grooves. Regarding the plurality of grooves that are spaced apart in a predetermined direction, after a laser beam is emitted by scanning in, for example, a direction perpendicular to the predetermined direction, the laser beam generation unit 2 is moved in a predetermined direction, and once again, a laser beam is emitted by scanning in the direction perpendicular to the predetermined direction. The plurality of grooves are formed by repeating this. It is to be noted that the grooves in the present embodiment include those observed with the naked eye and those observed under magnification by a microscope, magnifying glass, or the like, such as those observed under 200 times magnification.

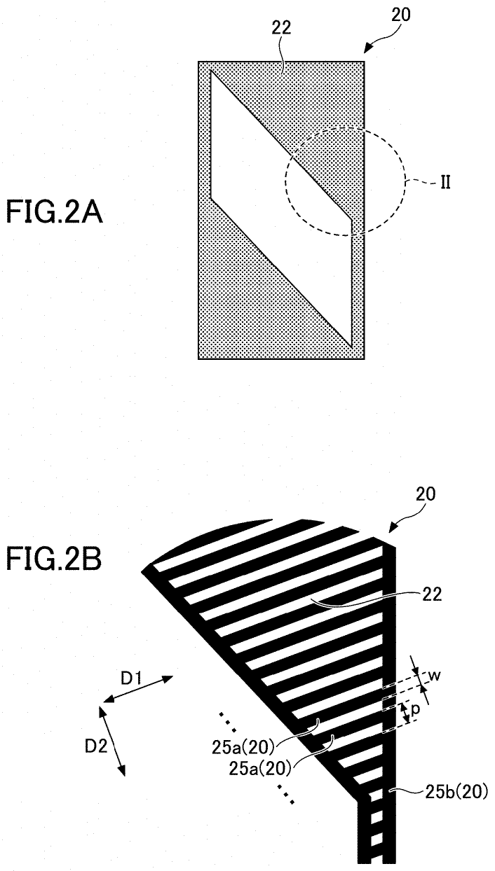

FIG. 2A illustrates an identification mark 20 of another design different from that in FIGS. 1A and 1B, and FIG. 2B illustrates an enlarged view of part II of FIG. 2A. In the present embodiment, an aggregate of multiple grooves 25 as illustrated in FIG. 2B can be formed in the roughened area 22 by scanning a laser beam as described above. More specifically, by scanning the laser beam along a scanning direction D1, the grooves are formed along the scanning direction D1, thereby forming grooves 25a, 25a, and . . . that are spaced apart and arranged in an orthogonal direction D2 perpendicular to the scanning direction D1. Since the original surface level (height) of the glass plate 10 is maintained in the portion between the grooves 25a, a fine structure of repeated elongated recesses and projections (grooves and ridges) can be formed in the roughened area 22 as viewed along the orthogonal direction D2. In such a structure, the reflective properties of light vary microscopically and regularly along the orthogonal direction D2, and thus, when viewed with the naked eye, the structure can be observed as a regular finely striped pattern or as a homogeneous area that appears to be colored in with a single color. Note that the scanning direction D1 is equal to the extending direction of the formed groove 25a.

In the example of FIG. 2B, although the grooves 25a are formed in a continuous linear shape extending from one position on the outline of the roughened area 22 to another position on the outline opposite the one position, but the grooves 25a may be discontinuous midway. However, it is preferable to emit the UV laser beam such that each groove 25a becomes a continuous groove from one position on the outline to another position on the opposite outline, because it is easier to impart the observer with a homogeneous visual effect in the roughened area 22.

Furthermore, in the roughened area 22, a groove 25b can be formed along the outline of the roughened area 22 as illustrated in FIG. 2B. By forming the groove 25b, the design of the identification mark 20 becomes clearer.

Each groove 25 can be formed by emitting the UV laser beam such that an illuminated spot has a diameter, i.e, a spot diameter, of 5 μm to 50 μm, preferably 15 μm to 40 μm. Since wider and deeper grooves can be formed in the roughened area 22 by setting the spot diameter to 10 μm or more, diffuse reflection in the roughened area 22 can be enhanced and the transparency can be reduced. In addition, by setting the spot diameter to 40 μm or less, the heat generated and remaining in the glass plate 10 by the laser beam can be reduced, and thus an occurrence of cracks or the like in the glass plate 10 can be prevented. By adjusting the spot diameter to the above range, the width w of the groove 25 formed can be 5 μm to 40 μm, or can be 10 μm to 30 μm, which is more preferable. The width w of the groove can be obtained by, for example, analyzing the planar view image.

In present embodiment, one groove 25 can be formed by one scan or by multiple overlapping scans, but it is preferable to form one groove 25 by one scan from the viewpoint of reducing the effect of heat and preventing an occurrence of cracks or the like in the glass plate. From the same viewpoint, it is preferable that the grooves 25 do not overlap each other or hardly overlap each other.

In the formation of the above multiple grooves 25, the spot diameters of the UV laser beam to be emitted may be kept the same or may be varied during the forming step. In a case where varying is chosen, when for example, a single groove 25 is being formed, the spot diameter may be changed midway, or the spot diameter of the UV laser beam to be emitted may be changed depending on the groove 25 to be formed. The spot diameter may be the same or may be varied in the step of forming the groove 25a and in the step of forming the groove 25b.

Similarly, the width of the groove 25 formed may be configured to be uniform within the roughened area 22 but need not necessarily be uniform within the roughened area 22. If not uniform, for example, the width in a single groove 25 may be varied, or, the width may vary on a per groove 25 basis. The width of the groove 25a and the width of the groove 25b may be the same or may be different.

In addition, the pitch p of the grooves 25a, 25a, and . . . that are formed spaced apart in the orthogonal direction D2 perpendicular to the scanning direction D1, that is, the minimum distance between the centerline of one groove 25a and the centerline of another groove 25a that is adjacent to the one groove 25a, may exceed the width w of the groove 25a. Alternatively, the pitch p may be a distance along the orthogonal direction D2 from the edge on one side of one groove 25a in the orthogonal direction D2 to the edge on the aforementioned one side of another groove 25a that is adjacent to the one groove 25a, as illustrated in FIG. 2B. The pitch p is preferably 3 μm or more, more preferably 7.5 μm or more, even more preferably 10 μm or more, even more preferably 40 μm or more, even more preferably 50 μm or more, and even more preferably 70 μm or more, and, preferably 1,000 μm or less, more preferably 500 μm or less, even more preferably 200 μm or less, even more preferably 150 μm or less, even more preferably 130 μm or less, and even more preferably 100 μm or less. In addition, in a case where the pitch p varies within the roughened area 22 of the identification mark 20, the average value of the pitch p is preferably 50 μm to 150 μm and more preferably 70 μm to 130 μm. The pitch p can be obtained by, for example, analyzing the planar image.

By setting the pitch p of the grooves 25a to 3 μm or more, the amount of heat per unit area that can be generated in the glass plate can be reduced, and thus an occurrence of cracks or the like in the glass plate can be prevented. In addition, considering the minimum beam diameter of the UV laser beam generation unit in the marking device, it is preferable that the diameter is 7.5 μm or more. On the other hand, by setting the pitch p of the grooves 25a to 1,000 μm or less, or, especially to 200 pm or less, the spacing between the grooves can be prevented from becoming too wide. That is, the transparency of the roughened area 22 approaching that of the non-processed area consequently causing the contrast between the roughened area 22 and the non-processed area to become smaller, and the localization of the grooves 25 becoming easy to notice consequently causing the sense of homogeneity in the roughened area 22 to be impaired can both be prevented.

The pitch p of the grooves 25a may be the same or different within the roughened area 22. In addition, the grooves 25a are preferably formed parallel to each other, but may be formed with a slant within +10 or −10 degrees from an exactly parallel state.

The aforementioned pitch p between the grooves 25a spaced apart and arranged in the orthogonal direction D2 in the identification mark 20 can be obtained by setting or controlling the scanning pitch of the UV laser beam generation unit in forming the grooves 25a, 25a, . . . , that is, the distance to be moved along the orthogonal direction D2, after the UV laser beam generation unit forms a groove by scanning along the scanning direction D1, to form the next groove. Therefore, the scanning pitch of the UV laser beam generation unit is preferably 3 μm or more, more preferably 7.5 μm or more, even more preferably 10 μm or more, even more preferably 40 μm or more, even more preferably 50 μm or more, and even more preferably 70 μm or more, and, preferably 1,000 μm or less, more preferably 500 pm or less, even more preferably 200 μm or less, even more preferably 150 μm or less, even more preferably 130 μm or less, and even more preferably 100 μm or less. The scanning pitch may be the same or may vary in the formation of a single identification mark. The pitch p between the grooves 25a to be formed is approximately the same value or range of values as the scanning pitch set by the marking device, but can be configured to be 0.85 to 1.15 times the scanning pitch in accordance with the type of glass plate, the conditions for forming the identification mark, and other conditions.

As described above, the UV laser beam is scanned over the glass plate when forming the grooves 25, and in such a case, the scanning speed of the UV laser beam is preferably 20 mm/sec to 1,200 mm/sec, more preferably 80 mm/sec to 250 mm/sec, and even more preferably 80 mm/sec to 160 mm/sec. When the scanning speed is 20 mm/sec or more, the effect of heat exerted by the laser beam on the glass plate can be reduced and cracks and the like can be prevented from occurring on the glass plate. Doing so can also enhance processing efficiency. With a scanning speed of 1,200 mm/sec or less, the grooves 25 of a certain width or more, a certain depth or more, or both a certain depth or more and certain width or more can be formed in the roughened area 22, that is, a portion having reflection properties different from that of the non-processed area.

In addition, the work distance (distance from the exit surface of the laser to a main surface of the glass plate) when emitting the UV laser beam is preferably 150 mm to 230 mm and more preferably 165 mm to 215 mm.

Although the laser beam can be scanned linearly or non-linearly to form the groove 25a in the roughened area 22, by scanning linearly, the irradiation efficiency can be improved and thus the work can be prevented from becoming cumbersome. Furthermore, in the obtained roughened area 22, the sense of homogeneity of the roughened area 22 is also enhanced by linearly extending each of the multiple grooves 25a spaced apart in the orthogonal direction D2.

In a case where the laser beam is emitted as a pulsed wave, the energy density of the emitted laser beam is preferably 100 kJ/m² to 50,000 kJ/m² and more preferably 250 kJ/m² to 2,500 kJ/m². The frequency is preferably 20 kHz to 60 kHz and more preferably 40 kHz to 50 kHz. In a case where the laser beam is oscillated as a continuous wave, the energy density of the emitted laser beam is preferably 100 kJ/m² to 50,000 kJ/m² or more preferably 250 kJ/m² to 2,500 kJ/m².

In the obtained identification mark 20, the roughened area 22 may have therein a property relating to a predetermined surface roughness. For example, a first arithmetic average roughness Ra1 of the grooves measured along the groove extending direction (scanning direction of laser beam) D1 is preferably 1.5 μm to 3.0 μm and more preferably 1.8 μm to 2.2 μm. A second arithmetic average roughness Ra2 measured along the orthogonal direction D2 perpendicular to the groove extending direction D1 is preferably 1.5 μm to 3.0 μm and more preferably 1.8 μm to 2.2 μm.

Furthermore, a first maximum height Rz1 of the groove measured along the groove extending direction D1 is preferably 10 μm to 40 μm and more preferably 15 μm to 30 μm. A second maximum height Rz2 measured along the orthogonal direction D2 perpendicular to the groove extending direction D1 is preferably 10 μm to 50 μm and more preferably 10 μm to 40 μm. Furthermore, the value of the ratio of the second maximum height Rz2 to the first maximum height Rz1 (Rz2/Rz1) is preferably 1 to 2 and more preferably 1.2 to 1.8.

Also, an average length RSm2 of the roughness curve elements measured along the direction D2 perpendicular to the groove extending direction D1 is preferably 50 μm to 150 μm and more preferably 70 μm to 130 μm. A mark with an RSm2 of 50 μm or more has a high aesthetic because heat generated when the grooves are formed is suppressed, thereby reducing an occurrence of cracks and the like in the glass plate. In a case where the RSm2 is 150 μm or less, the contrast between the roughened area and the non-processed area increases, and individual grooves are not noticeable, resulting in a high sense of homogeneity within the roughened area 22.

The arithmetic average roughnesses Ra (Ra1, Ra2), the maximum heights Rz (Rz1, Rz2) and the average length RSm (RSm2) of the roughness curve elements described above are roughnesses obtained in compliance with Japanese Industrial Standard JIS B 0601 (2001). The arithmetic average roughness Ra of the groove is the arithmetic average roughness Ra of the groove bottom, and this may be, for example, the arithmetic average roughness Ra measured along the centerline of the groove.

The total area of the roughened area 22 in the identification mark 20 may be 100 mm² to 10,000 mm². If an imaginary circle containing the identification mark 20 is drawn, the diameter of the imaginary circle may be 10 mm to 100 mm.

Also, the glass plate 10 in the roughened area 22 of the identification mark 20 is transparent, and the visible light transmittance of the glass plate 10 therein measured by the measurement method according to Japanese Industrial Standard JIS R 3106:1998 is preferably 70% or less and more preferably 60% or less.

### EXAMPLES

In these examples, a roughened area was formed on a glass plate using different methods. Specifically, plate-shaped unreinforced soda lime glass with a thickness of 3.5 mm and a length of 100 mm by a width of 100 mm, manufactured by a floating method, was prepared, and a square roughened area of 5 mm per side was formed on one main surface.

### Example 1

A pulsed wave UV laser beam (wavelength: 355 nm) was emitted using a laser marking device (Made by Keyence; MD-U1000C). The emitted light with an output power of 2.5 W, a frequency of 40 kHz, and a spot diameter of 25 μm was used to scan the laser beam along one side of a square of the roughened area to be formed under the conditions of a work distance of 189 mm and a scanning pitch of 80 μm to form multiple grooves spaced apart in the direction perpendicular to the scanning direction. Subsequently, a laser beam was emitted along the outline around the roughened area, thereby also forming a groove around the roughened area.

For the five grooves adjacent to each other, the roughness curves along the groove extending direction (scanning direction) were obtained, and the arithmetic average roughness (Ra1) and maximum height (Rz1) were individually obtained. In addition, the roughness curves along the orthogonal directions were obtained along five straight lines at predetermined intervals each extending along the direction perpendicular to the groove extending direction (orthogonal direction), and the arithmetic average roughness (Ra2) and maximum height (Rz2) were individually obtained. Furthermore, the length of the roughness curve element (RSm2) along the orthogonal direction was also determined. The results are illustrated in Table 1.

### Example 2

As a comparative example, a pulsed green laser beam (wavelength: 532 nm) was emitted using a laser beam generation device (Made by Keyence; MD-T1000W). Emitted light with an output power of 4 W, a frequency of 10 kHz, and a spot diameter of 20 μm was scanned at a work distance of 189 mm and a scanning pitch of 80 μm to form multiple grooves spaced apart in the direction perpendicular to the scanning direction of the laser beam. Subsequently, a laser beam was emitted along the outline around the roughened area, thereby also forming a groove around the roughened area.

The arithmetic average roughness (Ra1) and maximum height (Rz1) along the groove extending direction (scanning direction) and the arithmetic average roughness (Ra2), the maximum height (Rz2), and the length of roughness curve element (RSm2) along the orthogonal direction were determined as in Example 1. The results are illustrated in Table 1.

### Example 3

As another comparative example, a sandblasting device was used to form the roughened area using a stencil plate whose shape corresponded to the shape of the roughened area. In this example, sand blasting was carried out using abrasive sand with a diameter of 45 μm to 125 μm.

Since no grooves were formed in Example 3, the roughness curves were obtained along one side of a square in the roughened area along five parallel linear lines spaced approximately 80 μm apart from each other, and the arithmetic average roughness (Ra1) and maximum height (Rz1) were individually obtained. In addition, the roughness curves were obtained along another five parallel linear lines spaced apart from each other at predetermined intervals along a direction perpendicular to the aforementioned linear lines, and the arithmetic average roughness (Ra2), maximum height (Rz2), and length of the roughness curve element (RSm2) were individually obtained.

Table 1 illustrates each roughness value obtained in the Examples 1 to 3. Each value is an average value.

TABLE 1

| | Ra1 | Rz1 | Ra2 | Rz2 | RSm2*¹ | Rz2/Rz1 |
|---|---|---|---|---|---|---|
| Example 1 | 2.097 | 25.778 | 2.168 | 39.849 | 90.911 (21.022) | 1.55 |
| Example 2 | 13.21 | 162.062 | 13.943 | 138.527 | 320.172 (111.338) | 0.85 |
| Example 3 | 3.362 | 28.247 | 3.453 | 25.765 | 221.970 (118.716) | 0.91 |

*¹Number in parentheses is the standard deviation

The roughened areas obtained in the Examples 1 to 3 were observed with the naked eye. The roughened area (Example 1) formed by irradiation with the UV laser beam had a sense of homogeneity, and the outline of the roughened area was also clear. In contrast to this, in the roughened area formed using a green laser (Example 2) with a longer wavelength than that of the UV laser beam, and in the roughened area formed using sandblasting (Example 3), the impression was that diffuse reflection occurred heterogeneously within the area, and the outline of the roughened area was also unclear.

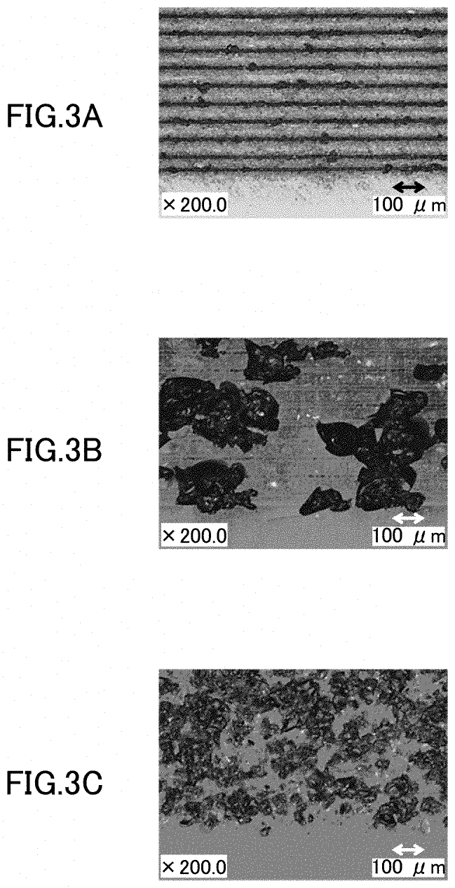

Further, the roughened areas were observed under magnification with a microscope. FIGS. 3A to 3C illustrate partial enlarged photos taken using coaxial epi-illumination of the roughened areas obtained in the Examples 1 to 3, respectively. As illustrated in FIG. 3A, in the roughened area (Example 1) formed by irradiation with the UV laser beam, multiple grooves spaced apart were regularly formed, and the outlines of the grooves were clear. In contrast to this, as illustrated in FIG. 3B, in the roughened area formed using a green laser (Example 2) with a wavelength longer than the UV laser beam, although multiple grooves could be observed, the outlines of the grooves were unclear, and the entire area was formed with an irregular unevenness due to the fine cracks that formed over the entirety of the glass plate. Also, as illustrated in FIG. 3C, the roughened area formed using sandblasting was uneven in the area where the surface was shaved.

What is claimed is:

1. A method of manufacturing an identification mark-bearing glass plate, the method comprising:
forming an identification mark on a main surface of a glass plate by emitting a UV laser beam.

2. The manufacturing method according to claim 1, wherein
the forming of the identification mark includes forming a plurality of grooves, the grooves being spaced apart in a predetermined direction, and
each groove is formed by emitting the UV laser beam such that an illuminated spot has a diameter of 10 μm to 40 μm.

3. The manufacturing method according to claim 2, wherein the groove has a predetermined width, and a pitch of the grooves exceeds the predetermined width.

4. The manufacturing method according to claim 3, wherein the predetermined width is 5 μm to 30 μm.

5. The manufacturing method according to claim 1, wherein a scanning speed of the UV laser beam is 40 mm/sec to 220 mm/sec.

6. The manufacturing method according to claim 1, wherein the UV laser beam is emitted at an energy density of 250 kJ/m² to 2,500 kJ/m² by using a pulsed oscillation technique.

7. The manufacturing method according to claim 6, wherein the identification mark is depicted by a roughened area in which a surface is roughened.

8. The manufacturing method according to claim 7, wherein a total area of the roughened area is 100 mm² to 10,000 mm².

9. An identification mark-bearing glass plate, wherein
a roughened area is formed in at least part of an identification mark, the roughened area being an area in which at least part of a surface of a glass plate is roughened,
in the roughened area, a plurality of grooves are formed, the grooves being spaced apart from each other, and
a transparency of the roughened area is lower than a transparency of a non-processed area that is an area other than the roughened area.

10. The identification mark-bearing glass plate according to claim 9, wherein a width of the groove is 5 μm to 30 μm.

11. The identification mark-bearing glass plate according to claim 10, wherein a pitch of the grooves exceeds the width.

12. The identification mark-bearing glass plate according to claim 9, wherein the groove has a linear shape.
